(19) United States
(12) Patent Application Publication
(10) Pub. No.: US 2007/0107586 A1
(43) Pub. Date: May 17, 2007

(54) Means and methods of sound synthesizing

(75) Inventor: Ho Yan Stephen Yip, Hong Kong Sar (CN)

Correspondence Address: BUCHANAN, INGERSOLL & ROONEY PC, POST OFFICE BOX 1404, ALEXANDRIA, VA, 22313-1404, US

(73) Assignee: Luminant Technology Ltd, Hong Kong SAR (CN)

(21) Appl. No.: 10/581,796

(22) PCT Filed: Jan. 14, 2005
(86) PCT No.: PCT/IB05/00073

§ 371 Date: Jun. 2, 2006

(30) Foreign Application Priority Data
Jan. 19, 2004 (CN) 04100430.4

(51) Int. Cl. G10H 1/02; G10H 7/00

(52) U.S. Cl. 84/627

(57) ABSTRACT

A method of sound synthesizing in which characteristics of a plurality of harmonics of a sampled sound are first absorbed into a wave-table so that a sound can be synthesized from a reduced number of harmonic envelops for efficient processing while preserving fidelity. This method is particularly good for synthesizing the sound of a string instrument.

### FIELD OF THE INVENTION

This invention relates to sound synthesizing and, more particularly, to schemes, means and methods of synthesizing musical sounds, such as the sound of musical instruments and the like. More specifically, although of course not solely limited thereto, this invention relates to the synthesizing of the sound of a string instrument such as violin, bass, cello and piano.

### BACKGROUND OF THE INVENTION

It is well known that an audible sound can be synthesised by electronic means. For example, voice messages can be synthesised from a plurality of basic vocal components for automated broadcasting and musical tones can be synthesised from a plurality of basic tone components for generating musical strings such as telephone ringing tones or other musical pieces. Typically, the synthesis is by electronic means more commonly referred to as “digital signal processors”.

It is perhaps common knowledge that an audio signal can be represented by a Fourier Series which comprises an indefinite plurality of weighted harmonics of a fundamental frequency. For a “natural” sound, as compared to a monotonic sound, the weighting of the harmonics is important and cannot be neglected as the totality of the harmonics provides the character of the sound.

While the Fourier technical facilitates means for an accurate representation of an audible signal to be reproduced, the processing power overhead required is prohibitive, since a calculation of at least 20 or 30 harmonics will be required to construct a Fourier series for a reasonable accurate reproduction of the sound of a musical instrument. Such a high demand on processing power requirements may not be readily met by portable devices, for example, mobile phone with tone or music generator, which are not solely dedicated for music or sound generation.

Jean-Claude Risset and Max v. Mathews advanced in the article entitled “Analysis of Musical Instrument Tones” Physics Today, vol. 22, no. 2, pp. 23-30 (1969), that the temporal evolution or the evolution in time of the spectral components of a sound is of critical importance in the determination of timbre. Therefore, it would be apparent that it is essential that the amplitude of each harmonic should be individually controlled as a function of time if a natural sound is to be reproduced with a reasonably high fidelity. Consequently, a powerful processor will be required in most cases for simulating each individual harmonics if the Risset theory is to be implemented using known techniques.

To alleviate the heavy demand on computational power, U.S. Pat. No. 4,018,121 (Chowning) proposed a FM synthesis method. However, it is noticed that the timbral quality of musical sound synthesized by this FM synthesizing method is not entirely satisfactory. More particularly, the synthesized sounds of string instruments, such as violin, cello, guitar or piano, lack the essential “depth” or “richness” to be real enough to be appreciated.

Hence, it would be highly beneficial if there can be provided improved means and methods of sound synthesizing so that audible sounds can be synthesized with a reasonable degree of fidelity while without requiring excessive computational overhead. The fidelity would preferably include a preservation of the “depth” or “richness” of the sound in case of the synthesis of the sound of string instruments.

### OBJECT OF THE INVENTION

Hence, it is an object of the invention to provide means and methods of sound synthesizing with a reasonable degree of fidelity but without requiring excessive computation. At a minimum, it is an object of this invention to provide alternative means and methods of sound synthesizing for the benefit and choice of the public.

### SUMMARY OF THE INVENTION

Broadly speaking, the present invention has described a method of synthesizing the sound of a musical instrument, including the steps of:—
obtaining samples of the sound of said instrument,
analysing the harmonics of said samples of said sound,
selecting harmonics of said sampled sound according to prescribed characteristics of the envelop of said harmonics for synthesizing harmonics of the synthesized sound,
grouping harmonics of said sampled sound of similar envelop characteristics and obtaining temporal characteristics of the group of harmonics from constituting harmonics of the same group,
synthesizing a plurality of synthesized harmonics of the synthesized sound, wherein at least some of the synthesized harmonics are synthesised from one of the envelops of the harmonics of a group and conditioned by the temporal characteristics of the constituting harmonics of that group.

Preferably, said prescribed characteristics for selecting a harmonic including selecting a harmonic with more salient variation in amplitude over-time.

Preferably, a plurality of selected harmonics of said sampled sound being group added to form a synthesized harmonic of the synthesized sound.

Preferably, said synthesized harmonic obtained by group addition being scaled up or down for generating other harmonics of said synthesized sound.

Preferably, said synthesized sound being synthesized from a plurality of characteristic harmonics, a plurality of said characteristic harmonics having a substantially similar envelope.

Preferably, the number of said plurality of characteristic harmonics does not exceed 4.

Preferably, at least one of said characteristic harmonics being synthesized from a plurality of harmonics of said samples of said sound.

### BRIEF DESCRIPTION OF THE DRAWINGS

Preferred embodiments of this invention will be explained in further detail below by way of example and with reference to the accompanying drawings, in which:—

FIG. 1 is a graph showing the amplitude-time characteristics of a plurality of more salient harmonics of an exemplary sound of a string instrument (this exemplary sound will be referred to as a “Synstring” signal below),

FIG. 2 shows the amplitude-time relationship of the first harmonic of the Synstring signal of FIG. 1,

FIGS. 3-6 respectively show the amplitude-time relationship of the second, third and fourth harmonics of the Synstring signal of FIG. 1,

FIG. 7 shows the amplitude-time characteristics of the fifth to the eighth harmonics of the Synstring signal of FIG. 1,

FIG. 8 shows the wavetable of the first synthesized harmonic,

FIGS. 9 and 10 respectively show the wavetable for the second and the third synthesized harmonics;

FIG. 11 shows the wavetable of the fourth group of the synthesized harmonics,

FIG. 12 shows the synthesized harmonics of the synthesized sound from the four groups of synthesized harmonics and their respective wavetables,

FIG. 13 shows, from top left and clockwisely, respectively, the envelops (amplitude-time) variation of the first to the fourth synthesized harmonic groups,

FIG. 14 is an amplitude-time diagram showing the waveform of the sound of a Synstring signal synthesized by the group additive synthesis of this invention, and

FIG. 15 shows the spectral diagram of the harmonics of the synthesized sound formed by the four groups of the synthesized harmonics.

### DETAILED DESCRIPTION OF THE PREFERRED EMBODIMENTS

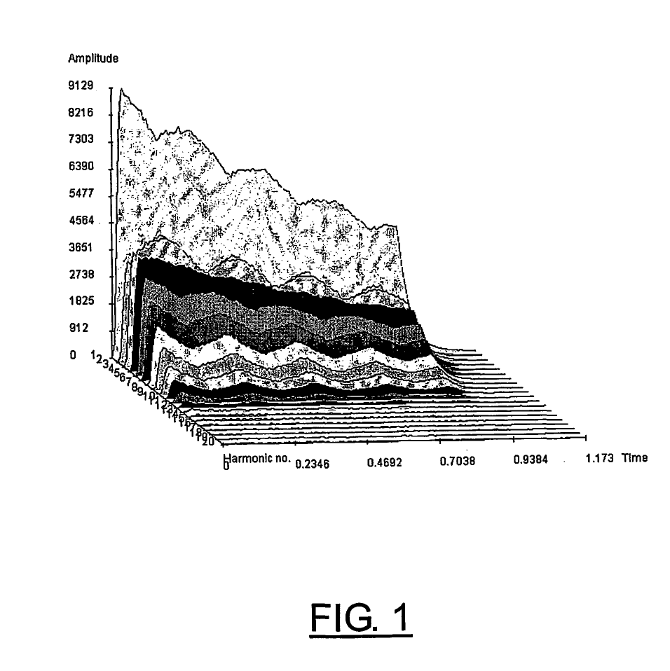

In the exemplary “Synstring” signal with a fundamental frequency of 440 Hz used for solely for convenient illustration and as shown in FIG. 1, it will be observed that the amplitude envelops of many of the harmonics are salient. If this Synstring signal is to be synthesised following the traditional Fourier approach, a substantial computational time and power would be required and this would make the synthesis of a music string impractical, if not impossible, for many applications, for example, for mobile phone or other portable applications. Although the term “Synstring” is usually understood by persons skilled in the art as meaning a synthesized sound of a string instrument such as violin, viola, cello, guitar and piano, this term when used in this specification does not limit to such and would include both synthesised and natural sounds of a string instrument where the context permits

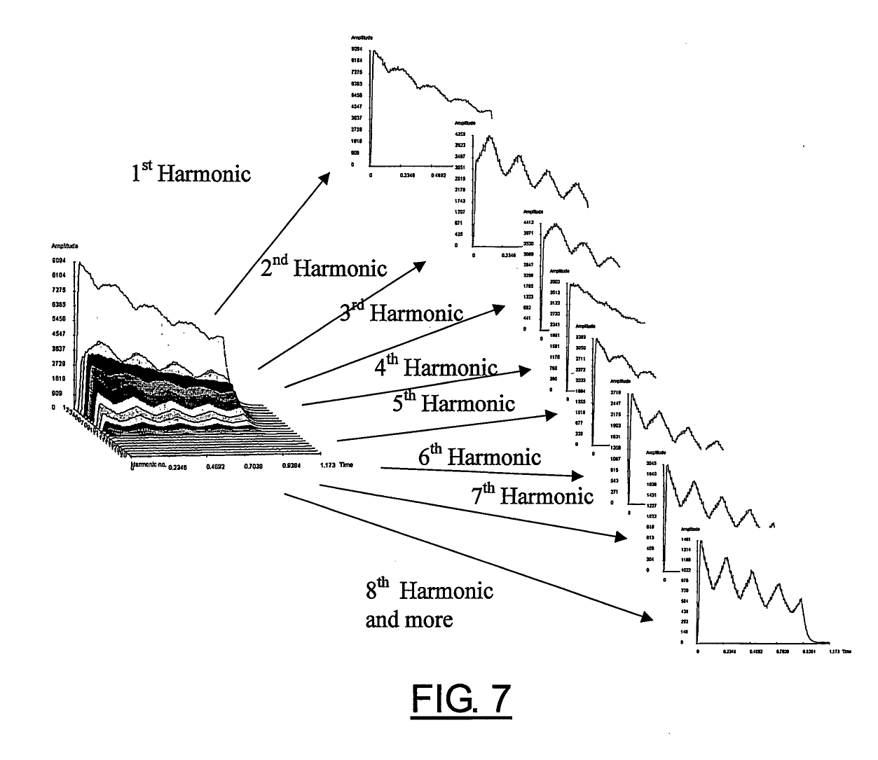

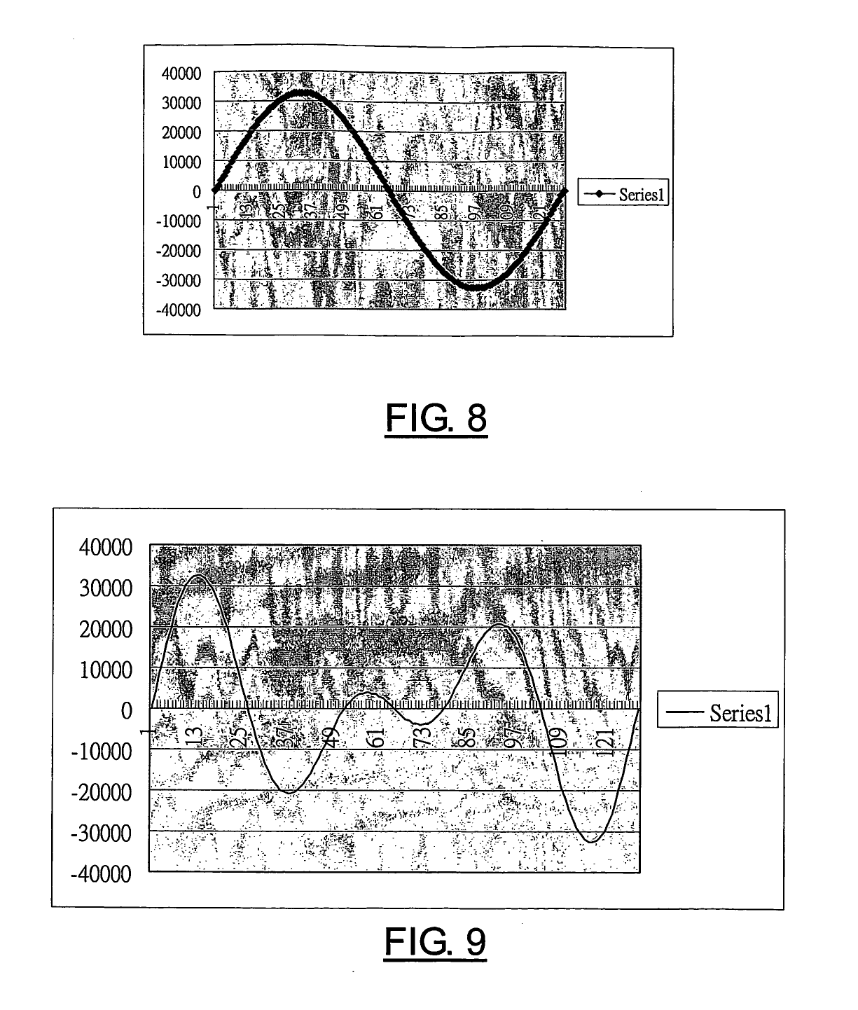

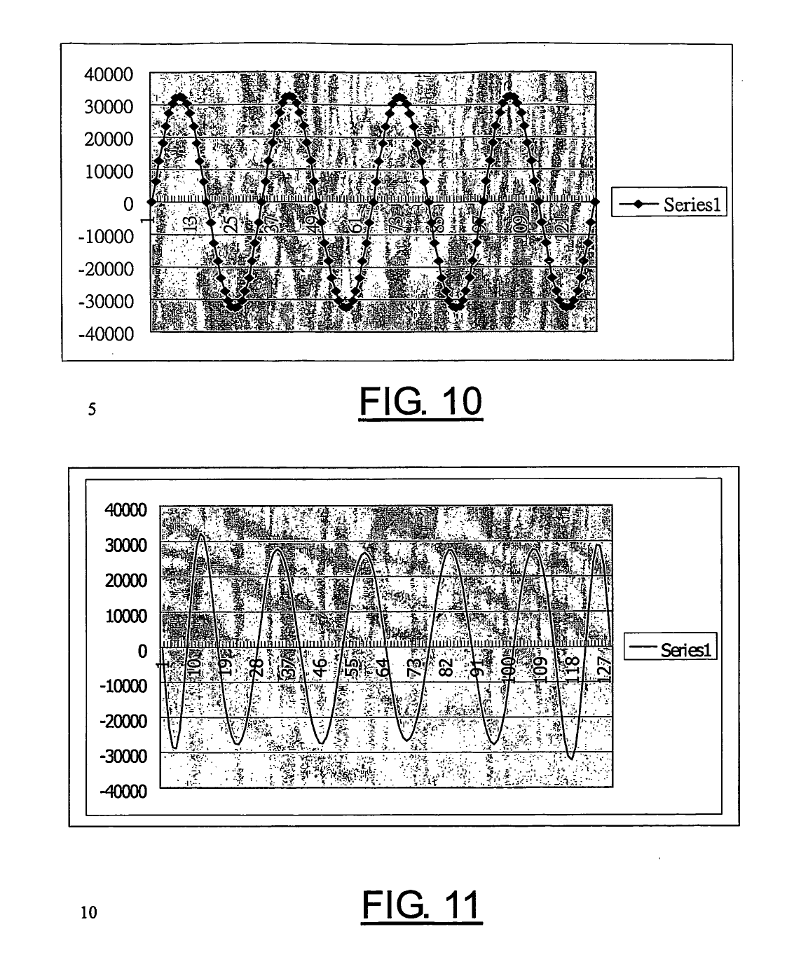

A possibility to obviate the need of a dedicated processor with high computational power is to reduce the number of harmonics, for example, by using only the most salient harmonics and giving up the other harmonics to ease computational demand. However, since it is known that the timbral quality of an instrument is a collective effect of the ensemble of the more salient harmonics, the timbral quality of a synthesised sound, especially a synthesis sound of a string instrument, by such a simplistic selection method is not generally satisfactory. In the text below, an exemplary scheme for synthesising an exemplary Synstring signal from a plurality of harmonics is described. By applying the same scheme mutatis mutandis, a plurality of synthesised Synstring signals of various different fundamental frequencies could be synthesised. Naturally, such synthesised Synstring signals can be used to put together a short musical string or a short musical piece with a reasonable timbral quality, for example, quality reminiscent to that of string instruments. Referring firstly to the exemplary spectrum of FIG. 1, there is shown the harmonics of an exemplary Synstring signal with a fundamental frequency of 440 Hz. The schematic representation of FIG. 7 shows the more salient harmonics of the Synstring signal, it will be noted that among the 20 odd harmonics that are shown in the Figures, the amplitude-time variation of the first eight harmonics are particularly noticeable or salient. Among the 8 more salient harmonics, the first four or five harmonics could be regarded as the dominant harmonics. For most practical purposes, it will be appreciated that a Synstring signal synthesised from the first 8 harmonics would produce a sound of a satisfactory timral quality. In other words, the Synstring signal can be adequately represented by the 8 most salient harmonics in this example. However, to synthesize the sound using all the 8 harmonics still requires a very substantial processing power as well as a massive data storage which is not realistic for many practical applications. In the description below, a scheme to combine the audio effects of the eight most salient harmonics of an exemplary Synstring signal into four groups of synthesised harmonics will be described. It is appreciated that such a synthesised Synstring signal provides a satisfactory timbral quality of a string instrument with only four synthesised harmonics.

Referring to FIGS. 1 and 7, it can be observed that the first harmonic, that is, the fundamental frequency, of the sampled Synstring sound has the most dominant amplitude characteristics and the envelop shape of this harmonic is unique among the other more salient harmonics, this first harmonic is selected to form the first group of the synthesized harmonic and will be referred to as the “first synthesised harmonic group” below.

The second synthesized harmonic group comprises the second and the third harmonics of the sampled sound. Such a grouping selection is made because the second and the third harmonics exhibit similar characteristics on variations of amplitude with time (as reflected by the trend of the tooth-shaped envelope).

The envelope of the third harmonic of the sampled sound is used as a reference for synthesizing the envelope of the second group of synthesized harmonics of the synthesized sound because the envelope of the third harmonic has the larger and therefore more dominant amplitude in this group.

The third synthesised harmonic group consists of the fourth harmonic of the sampled sound since it can be seen that the fourth harmonic has a unique amplitude-time variation which is very different from the remaining of the harmonics of the sampled sound. Hence, the envelope of the third group of the synthesized harmonics is also the envelope of the fourth harmonic of the sampled sound.

As the remaining harmonics of the sampled sound, namely, the fourth to eighth harmonics, have a similar saw-tooth envelop trend and have comparable relative amplitudes, they are expected to make similar contribution to timbral quality and are therefore grouped together to form the fourth synthesized harmonic group. Furthermore, as the shape of the saw-tooth envelop of the sixth harmonic is more salient, that is, the amplitude between adjacent peaks and troughs are more significant, the envelop of the sixth harmonic is chosen as a normalizing reference and envelop to be explained below.

When synthesising a harmonic group from two or more contributing harmonics, the relative amplitude contribution of each of the contribution harmonics is preserved, for example, by adding the amplitude of each of the contributing harmonics with the correct timing (or temporal) relationship. Due to the characteristic nature of harmonic, it will be appreciated that the amplitude envelop of each of the higher harmonics must repeat at least once within each cycle or period of the fundamental frequency. For example, the amplitude variation of the second, third and fourth harmonics will repeat once, twice and three times during the period of a fundamental cycle. Hence, the contribution of the individual harmonics will be fully characterised if their relative amplitudes are processed for a full fundamental cycle. For example, for a signal of a fundamental frequency of 440 Hz, the period of a fundamental cycle is 1/440 second. Thus, in this example, the relative amplitude contribution of the harmonics will be calculated for a full fundamental cycle duration of 1/440 seconds.

To construct the synthesized harmonics, a plurality of wave-tables are constructed as a convenient tool for illustration and to facilitate easy look up for digital based processors. As a convenient example, a wave-table with a table size of 128 entries is used for illustration. As a full signal cycle can be represented by a cycle of 360°, each entry in the wavetable represents 2.8125°. For an exemplary 16 bit system, the signal amplitude can be resolved into 32767 levels. The exemplary wave-table constructed for the first harmonic of the sampled sound is shown in Table A below as a convenient example. As the first synthesised harmonic group comprises only of the fundamental or first harmonic frequency, the wave-table is a practically a sine table scaled up to 32767, the maximum value for a 16-bit system.

TABLE A

| Degree | Radian | SineValue | Scaled up to32767 |
|---|---|---|---|
| 0 | 0 | 0 | 0 |
| 2.8125 | 0.049087 | 0.049068 | 1607 |
| 5.625 | 0.098175 | 0.098017 | 3211 |
| . . . | . . . | . . . | . . . |
| 45 | 0.785398 | 0.7071068 | 23169 |
| . . . | . . . | . . . | . . . |
| 90 | 1.570796 | 1.0 | 32767 |
| . . . | . . . | . . . | . . . |
| 180 | 3.14159 | 0.0 | 0 |
| . . . | . . . | . . . | . . . |
| 270 | 4.712389 | −1.0 | −32767 |
| . . . | . . . | . . . | . . . |
| 360 | 6.2832 | 0 | 0 |

As the second synthesized harmonic group comprises contribution from the second and third harmonics of the sampled sound, a wave-table with contribution from the second and third harmonics is constructed. As an example, the wave-table is constructed by adding the corresponding temporal amplitude values of the second and third harmonics as shown in Table B below. In building up the wave-table (Table B) for the second synthesised group, sine values of the second and third harmonics are superimposed together with both the second and third harmonics initialised and synchronised with the fundamental. The wave-table is tabulated with respect to the fundamental frequency and with the relative weight of the harmonics adjusted. Furthermore, since there are respectively two and three full wave cycles of the second and third harmonics in a single cycle of the fundamental wave, the tabulation of second and third harmonic cycles in a full fundamental cycle will fully reflect the effect of their superposition. The general shape of the superimposed second and third harmonics with weight adjustment is shown in a complete fundamental cycle in FIG. 9.

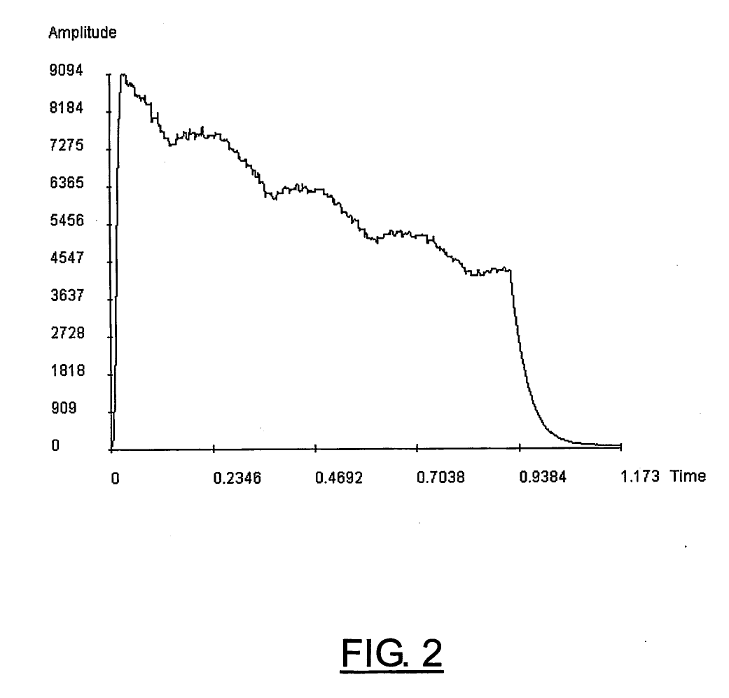

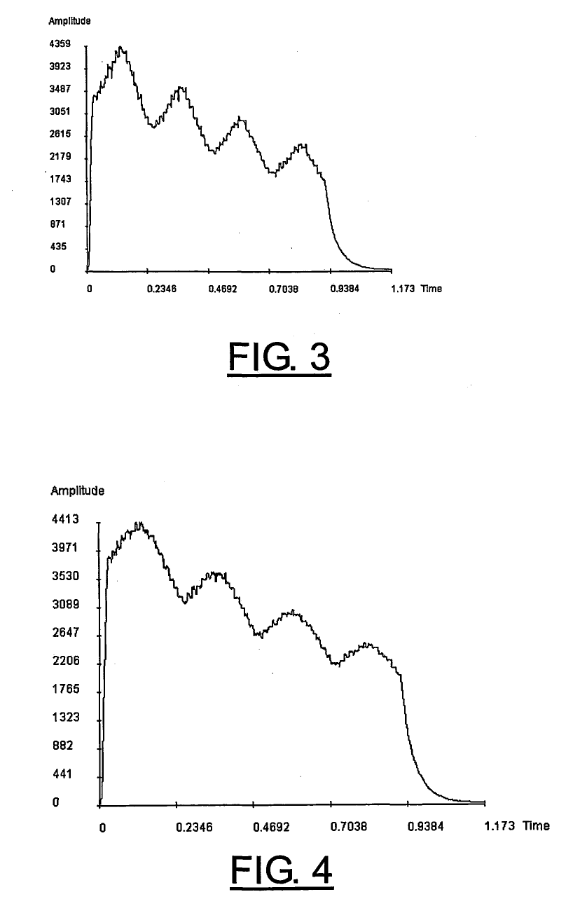

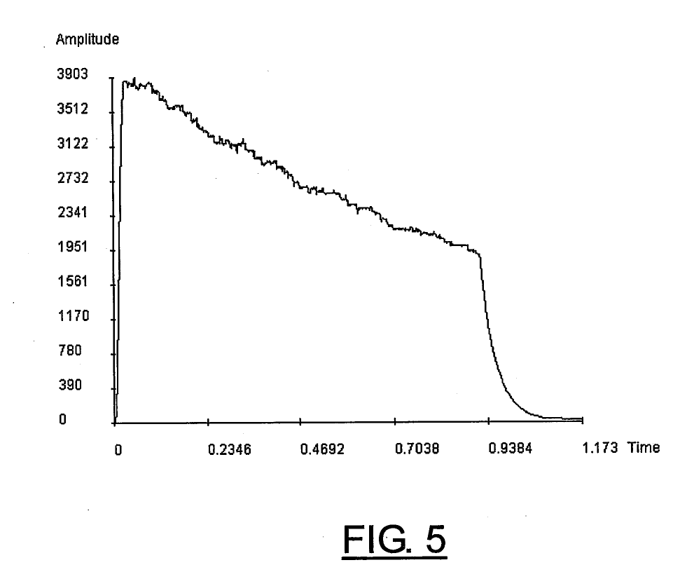

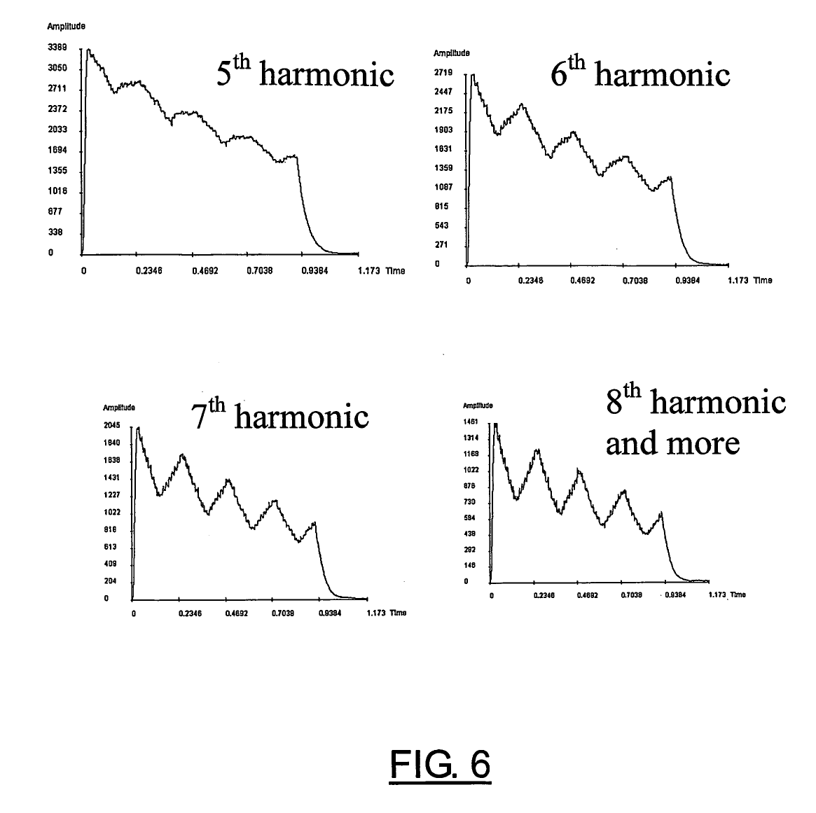

In order to factor in the relative significance of the component harmonics, the relative weight of the second and third harmonics are taken into account before the respective temporal values are summed. The sine value of the second harmonic is multiplied by a scaling factor before adding with a corresponding value of the third harmonics. A scaling factor of 0.988 is used in this specific example. This scaling factor is obtained by dividing the value of the peak amplitude of the second harmonic (which is 4359 as shown in FIG. 2 on the 32767 level) by the peak amplitude value of the third harmonic (which is 4413 as shown in FIG. 3), that is, 4359/4413=0.988 as a convenient way to reflect the relative contribution of the second and third harmonics. Thus, the individual entries of the wave-table for the second synthesised harmonic group are obtained by adding i) 0.988×the respective sine values of the second harmonic and ii) the respective sine values of the third harmonic. By this formulae, the maximum entry is about 1.9, which occurs at about 33.75°. This sum is scaled down or normalized by the factor of 1.9 to ensure that the maximum does not exceed 1 or 32767. The amplitude of the envelop of the third harmonic of the second synthesised harmonic group is subsequently scaled up by the same factor 1.9 to reflect the totality of the contribution of the second and third harmonics so that distortion due to the scaling down is compensated or mitigated.

TABLE B
(Excerpt)

| | SineValue | | | |
|---|---|---|---|---|
| | 2^{nd} | | | |
| Degree (wrt | harmonic × | 3^{rd} | | Scaled up by |
| fundamental) | 0.988 | Harmonic | Sum | 32767/1.9 |
| 0 | | | | |
| 2.8125 | 0.096818 | 0.146730 | 0.243548 | 4200 |
| 5.625 | 0.098175 | 0.192703 | 0.42988 | 8329 |
| . . . | | | | |
| 11.25 | 0.378000 | 0.555570 | 0.933571 | 16100 |
| . . . | | | | |
| 33.75 | 0.912574 | 0.980785 | 1.89336 | 32652 |
| . . . | | | | |
| 45 | 0.988 | 0.707107 | 1.7071 | 29229 |
| . . . | | | | |
| 90 | 0.0 | −1 | | −17246 |
| . . . | | | | |
| 180 | 0 | 0 | | 0 |
| . . . | | | | |
| 270 | 0 | 1 | | 17246 |
| . . . | | | | |
| 360 | 0 | 0 | | 0 |

The third synthesized harmonic group consists of the fourth harmonic of the sampled sound. Similar to the first synthesised group, the wave-table of the third synthesized harmonic group is a table of scaled-up sine values tabulated with respect to angular displacement of the fourth harmonic and with a time span equal to T, where T=1/f and f is the fundamental frequency. Thus, this wave-table comprises the tabulation of four full cycles of the third harmonic with the peak value scaled up to 32767, as illustrated in FIG. 11.

The fourth synthesized harmonic group is obtained by group additive synthesis of the remaining more salient harmonics. Specifically, a wave-table with a time span equal to T is calculated by adding the corresponding temporal values of the fifth to the twelve harmonics with weight adjustment similar to the synthesis of the second synthesised harmonic group. Since the time span is T, five, six, seven, etc full cycles respectively of the fifth, sixth, seventh, etc harmonics are contained in this wave-table.

The envelope of the sixth harmonic is selected as a reference because of its more characteristic salient saw-tooth shape. Before group adding the harmonics, the sine values of each of the harmonics are weight adjusted. For example, the fifth harmonic is scaled up a factor of 1.25, which is the ratio between the peak amplitude of the fifth harmonic (3389) and the sixth harmonic (2719) (1.25=3389/2719). The sine values of the seventh harmonic is scaled down by a factor of 0.75 (being 2045/2719), the sine values of the eighth harmonic is scaled down by a factor of 0.54 (being 1481/2719) and scaling of the remaining harmonics apply mutatis mutandis, where 2719 is the peak amplitude of the sixth harmonic in the scale of FIG. 1. When a wave-table for the fourth synthesised harmonic is constructed according to the above, it is noted that the maximum value appearing is 2.2. Hence, every entry in the wave-table is divided by 2.2 so that the entry with maximum value is normalised to “1” and corresponds to the value of 32767 in a 16-bit system. Likewise the time-amplitude envelope of the sixth harmonic has to be scaled up by the same factor 2.2 to compensate for the scale down of the wave-table.

Although the contribution by each of the fifth to twelve harmonics has been used to construct the wave-table of the fourth synthesised harmonic group, it will be appreciated that the harmonics beyond the eighth are already less significant and their inclusion is merely for further enhancement of a timbral quality. It will be appreciated that the inclusion of the fifth to the eighth harmonics in the wave-table for the fourth synthesised harmonic group would have given a reasonable timbral quality already.

After the four wave-tables have been prepared, the four characteristic synthesized harmonic groups will be synthesized utilising the wave-tables to be explained below.

Broadly speaking, the first synthesised harmonic group is synthesised from the first harmonic of the sampled sound and the first wave-table (which is actually a tabulation of the sinusoidal values of the first harmonic). The second synthesized harmonic group is synthesised from the second harmonic of the sampled sound and the second wave-table (which is obtained from scaled superposition of the sinusoidal values of the second and third harmonics). The third synthesized harmonic group is synthesised from the fourth harmonic and the third wave-table, which is actually a tabulation of the sinusoidal values of the fourth harmonic. The fourth synthesized harmonic group is synthesised from the sixth harmonic of the sampled sound and the fourth wave-table (which is obtained from scaled superposition of the sinusoidal values of the fifth to twelve harmonics).

Specifically, the envelop of the first synthesised harmonic group is obtained by multiplying the envelop of the first sampled harmonic with the first wave-table. The envelop of the second synthesised harmonic group is obtained by multiplying the envelop of the second (or third) sampled harmonic with the second wave-table with a first weight factor of 1.9 to reflect the relative weight contribution by the second and third sampled harmonics. This weight factor of 1.9 is the restoration of the scaled down factor of 1.9 during the formation of the second wave-table. The envelop of the third synthesised harmonic group is obtained by multiplying the envelop of the fourth sampled harmonic with the third wave-table and with a second weight factor to reflect the relative weight contribution by the second and third sampled harmonics. The envelop of the fourth synthesised harmonic group is obtained by multiplying the envelop of the sixth sampled harmonic with the fourth wave-table as scaled by a third weight factor of 2.2 to reflect the relative weight contribution by the sampled harmonics. Similarly, the scale factor of 2.2 restores the adjustment due to scaling during formation of the fourth wave-table.

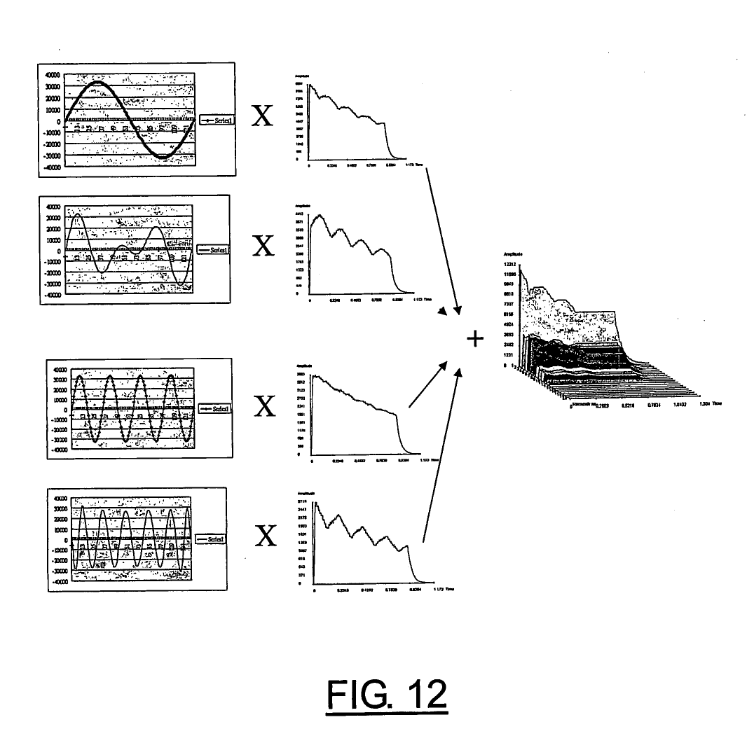

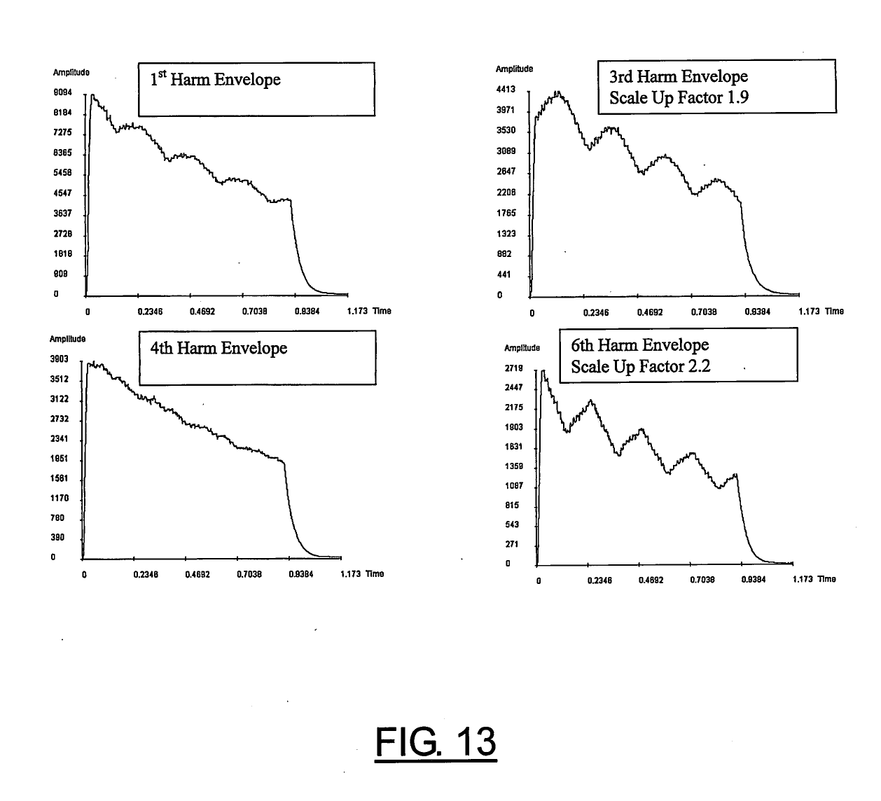

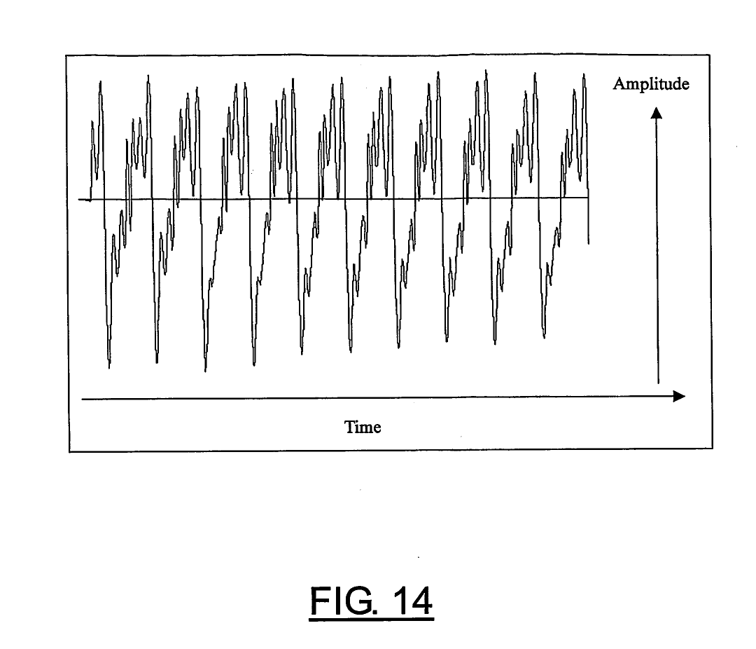

The formation of the synthesised Synstring signal and the spectral characteristics of the resultant synthesised Synstring signal is graphically shown in FIG. 12. The amplitude-time envelope of the first to the fourth synthesized harmonic groups are shown in FIG. 13.

The actual numerical processing to form the envelops of the four synthesised harmonic groups will be described next. Firstly, each of the more salient amplitude wave-tables, the four synthesised harmonic groups are partitioned into a array comprising a plurality of time slots each with a width, for example, of 0.02 second. The amplitude-time envelopes of the first to the fourth synthesized harmonic groups are sliced into a plurality of intervals of 0.02 s width. Of course, other values of slot width can be used. Arrays containing the values of individual time-amplitude envelopes are constructed from the selected envelopes normalized by the scale up factor (i.e. envelopes of the first harmonic, third harmonic with scale up factor 1.9, fourth harmonic and sixth harmonic with scale up factor 2.2). Due to the changes of the relative amplitude of the envelopes against each other, the temporal evolution characteristic of musical sound can be synthesized. Furthermore, the amplitude value of a particular synthesized harmonic group at a particular time is looked up from the array. The value is then multiplied by the corresponding level value from the wavetable at the desired frequency. Put simply, the wavetable is to synthesize the spectrum of a musical sound. The time-amplitude envelope is to synthesize the temporal evolution of a musical sound. These two are the most two important characteristics of synthesizing a musical sound.

As the respective wavetables for the particular synthesised harmonic contain the values of the relevant temporal evolution information of the respective constituting harmonics of the sampled sound, the multiplication by the wavetables of the selected harmonic envelope imparts the quality of the constituting sampled harmonics to the selected envelope. For example, the second synthesized harmonic group is built on the time-amplitude envelope of the third harmonic of the sampled, by multiplying the envelope of the sampled third harmonic with the second wavetable which contains temporal evolution elements of both the second and the third sampled harmonics, the temporal characteristics of the second and third sampled harmonics are imparted onto the second synthesized harmonic. This applies mutatis mutandis to the fourth synthesised group.

As a specific example, the synthesizing of a 440 Hz Synstring signal at a sampling rate of 44 kHz is illustrated. As the lookup wavetable has a total of 128 entries, each entry on the wavetable will represent 344.5 Hz (44.1 kHz/128).

At 344.5 Hz, the lookup address of the wavetable needs to be incremented by one to obtain the desired first harmonic wavetable. If we want to have a frequency of 440 Hz is desired, the index will be exceeding 1 for the lookup address of the wavetable which is given by the following formula:
e.g., the index will be 440 Hz/344.5 Hz=1.277

That means at each sampling at 44.1 kHz, the lookup address will be incremented by 1.277 instead of 1 and the desired 440 Hz can be represented by the 128 entries of the first harmonic wavetable.

To regenerate the sound of a Synstring signal at frequency 440 Hz, the corresponding table and amplitude will be multiplied and the four groups of synthesized harmonics will be lumped together.

An example of a simple program to synthesize the 440 Hz Synstring sound is set out below.

Accumulator: wavetable lookup address

Index: increment at the desired frequency

Table: table array of the wavetable above

Coefficient: a calculated result from table array of the amplitude above,

Synstring: the pcm output value

At 44.1 kHz sampling, the output is calculated at the sampling as follows:

Accumulator = Accumulator+Index;
if (Accumulator>=128)

Accumulator = Accumulator−128;

Synstring=Table1[Accumulator]*Coefficient1;
Synstring=Synstring+Table2[Accumulator]*Coefficient2;
Synstring=Synstring+Table3[Accumulator]*Coefficient3;
Synstring=Synstring+Table4[Accumulator]*Coefficient4;

The coefficient is calculated at every 0.02 sec as follows:
Coefficient: the calculated result from amplitude and volume
Scale: the scaling factor to normalize the volume of a musical instrument with other musical instrument
Volume: the sound volume of the desired musical instrument

The amplitude loop-up from the amplitude envelope using the elapsed time as the lookup address will be as follows:

For example, the elapsed time from the turn on of Synstring instrument at 440 Hz is 0.03 sec, the amplitude at 0.02 sec is used. If the volume is 10 and the scale factor is 5, the coefficient for amplitude1 is 8852*10*5=442600. Hence, 442600 will be the Coefficient1 above until the end of 0.04 sec which will be used as the next value to 8852 in the line.

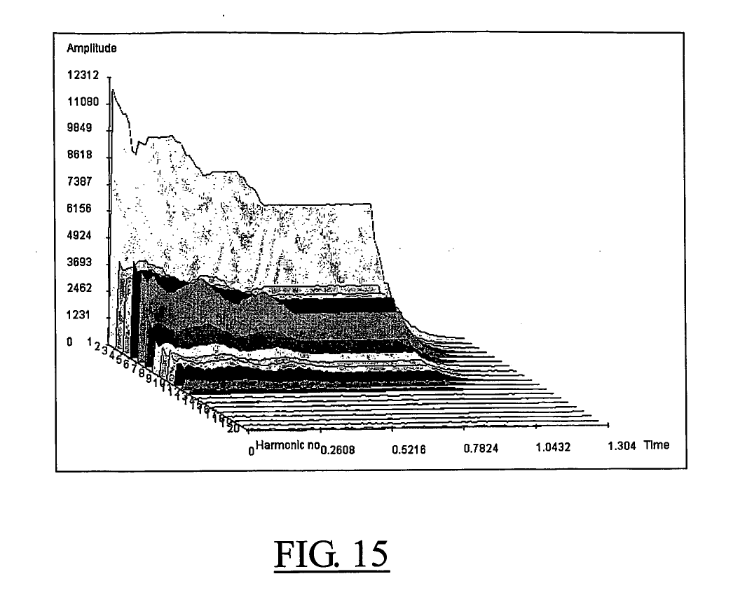

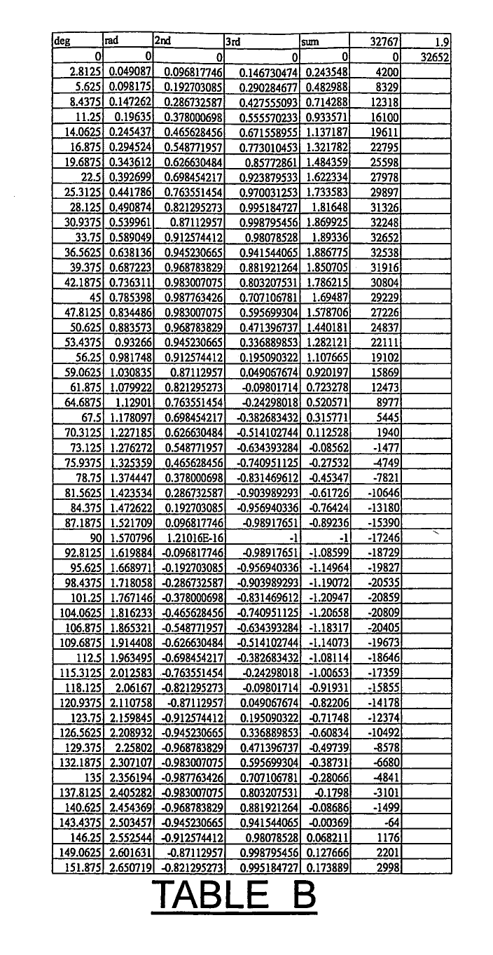

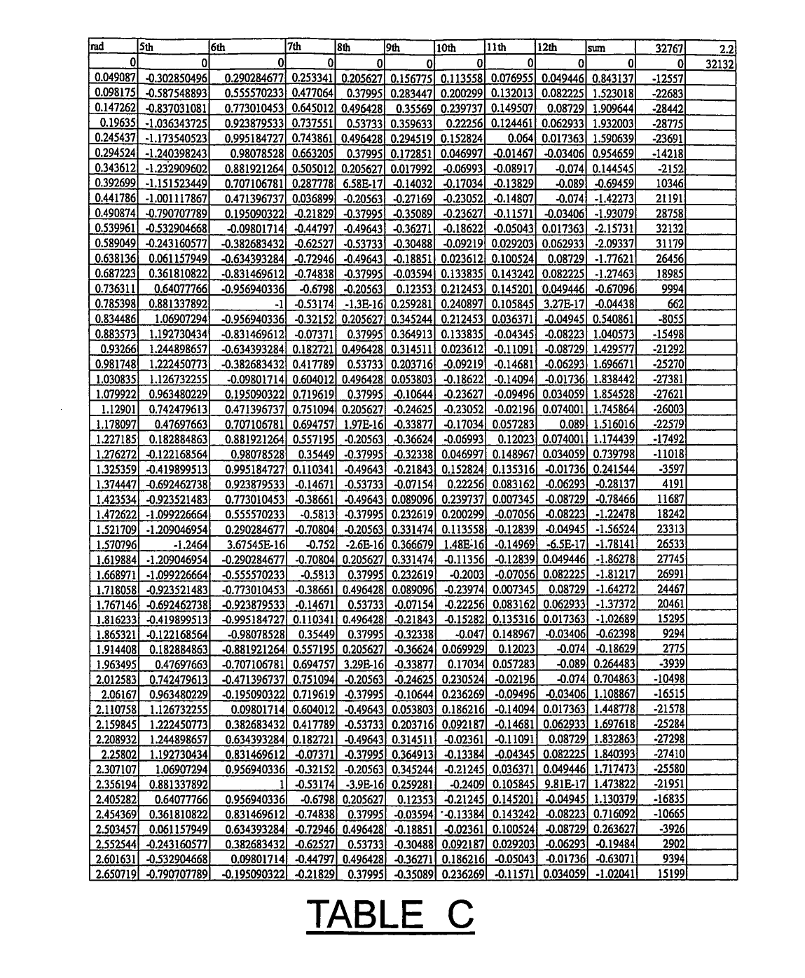

The synthesized waveforms of the exemplary 440 Hz Synstring sound in a spectral harmonics representation are shown respectively in FIGS. 15 and 16.

It will be noted from the spectral diagram of FIG. 15 that the spectrum of the synthesized sound obtained from the above group additive synthesis is more uniform than that obtained from FM synthesis or the original sample. In particular, a plurality of the harmonics of the synthesized sound have the substantially same variation in the amplitude envelop.

In general, audio signals can be represented by as follows:

Where,

S(t): Signal at time t,

Ai(t): Amplitude of ith harmonic at time t,

S(t)=Σi Ai(t)*sin(2*π*i*f*t), and

i from 0 to n

In the sound of Synstring, this is reduced to as follows:

$$S ( t ) = B 1 ( t ) * sin ( 2 * π * f * t ) + B 2 ( t ) * ( 0.988 * sin ( 2 * π * 2 * f * t ) + sin ( 2 * π * 3 * f * t ) ) + B 3 ( t ) * sin ( 2 * π * 4 * f * t ) + B 4 ( t ) * ( - 1.25 * sin ( 2 * π * 5 * f * t ) ) + sin ( 2 * π * 6 * f * t ) ) + … )$$

Where B(t) is the normalized amplitude envelope.

This allows the sound to be generated by only 4 table lookups, 4 multiplications and 4 additions at the prescribed sampling rate which greatly reduces the processing power required.

While the present invention has been explained by reference to the examples or preferred embodiments described above, it will be appreciated that those are examples to assist understanding of the present invention and are not meant to be restrictive. The scope of this invention should be determined and/or inferred from the preferred embodiments described above and with reference to the Figures where appropriate or when the context requires. In particular, variations or modifications which are obvious or trivial to persons skilled in the art, as well as improvements made thereon, should be considered as falling within the scope and boundary of the present invention.

Furthermore, while the present invention has been explained by reference to the specific ground additive synthesis outlined above, it should be appreciated that the invention can apply, whether with or without modification, to other synthesizing scheme utilizing a plurality of the harmonics of the sampled sound to construct the synthesized sound without loss of generality.

1. A method of synthesizing the sound of a musical instrument, including the steps of:—
obtaining samples of the sound of said instrument,
analysing the harmonics of said samples of said sound,
selecting harmonics of said sampled sound according to prescribed characteristics of the envelope of said harmonics for synthesizing harmonics of the synthesized sound,
grouping harmonics of said sampled sound of similar envelope characteristics and obtaining temporal characteristics of the group of harmonics from constituting harmonics of the same group,
synthesizing a plurality of synthesized harmonics of the synthesized sound, wherein at least some of the synthesized harmonics are synthesised from one of the envelopes of the harmonics of a group and conditioned by the temporal characteristics of the constituting harmonics of that group.

2. A method of claim 1, wherein said prescribed characteristics for selecting a harmonic including selecting a harmonic with more salient variation in amplitude over-time.

3. A method of claim 1, wherein a plurality of selected harmonics of said sampled sound are group added to form a synthesized harmonic of the synthesized sound.

4. A method of claim 3, wherein said synthesized harmonic obtained by group addition are scaled up or down for generating other harmonics of said synthesized sound.

5. A method of claim 1, wherein said synthesized sound is synthesized from a plurality of characteristic harmonics, a plurality of said characteristic harmonics having a substantially similar envelope.

6. A method of claim 5, wherein the number of said plurality of characteristic harmonics does not exceed 4.

7. A method of claim 5, wherein at least one of said characteristic harmonics is synthesized from a plurality of harmonics of said samples of said sound.

8. A sound synthesized from claim 1, wherein a plurality of the harmonics of the synthesized sound have substantially the same variation in the amplitude envelope.

9. A sound according to claim 8, wherein the synthesized sound is reminiscent of the sound of a string instrument.

10. A sound synthesized from claim 2, wherein a plurality of the harmonics of the synthesized sound have substantially the same variation in the amplitude envelope.

11. A sound synthesized from claim 3, wherein a plurality of the harmonics of the synthesized sound have substantially the same variation in the amplitude envelope.

12. A sound synthesized from claim 4, wherein a plurality of the harmonics of the synthesized sound have substantially the same variation in the amplitude envelope.

13. A sound synthesized from claim 5, wherein a plurality of the harmonics of the synthesized sound have substantially the same variation in the amplitude envelope.

14. A sound synthesized from claim 6, wherein a plurality of the harmonics of the synthesized sound have substantially the same variation in the amplitude envelope.

15. A sound synthesized from claim 7, wherein a plurality of the harmonics of the synthesized sound have substantially the same variation in the amplitude envelope.
